(19) United States
(12) Patent Application Publication
(10) Pub. No.: US 2025/0207440 A1
(43) Pub. Date: Jun. 26, 2025

(54) DOUBLE PULL INSIDE DOOR HANDLE MECHANISM WITH ELECTRICAL AND MECHANICAL ACTUATION

(71) Applicant: NOVARES US LLC, Livonia, MI (US)

(72) Inventors: David Brent Egnor, Ypsilanti, MI (US); Scott Neideck, Farmington Hills, MI (US)

(21) Appl. No.: 18/983,555

(22) Filed: Dec. 17, 2024

Related U.S. Application Data
(60) Provisional application No. 63/613,358, filed on Dec. 21, 2023.

(51) Int. Cl. E05B 85/14; E05B 81/54

(52) U.S. Cl. CPC E05B 85/14; E05B 81/54; E05Y 2900/531

(57) ABSTRACT

A door handle mechanism includes a fixed base and a slider and lever attached to the fixed base. The lever is actuated in a first direction through a first range of travel to actuate an electrical switch to provide electrical actuation of a door latch. Additional actuation in the same direction through a second range of travel with the same kinematic movement causes translation of the slider relative to the fixed base. Movement of the slider pulls a cable attached to the latch to provide a mechanism release function on the latch. The slider moves linearly and pulls on the cable linearly. The handle portion of the lever is lifted upward in the first and second ranges of travel. The actuation portion of the lever moves downward, and cams against the slider in the second range of travel.

### CROSS REFERENCE TO RELATED APPLICATIONS

This application claims the benefit of the filing date under 35 U.S.C. § 119(e) of U.S. Provisional Application No. 63/613,358 filed on Dec. 21, 2023, the entire content of which is incorporated herein by reference in its entirety.

### FIELD

The present disclosure related generally to an inside door handle mechanism for actuating a power operated door latch of a vehicle. More particularly, the present disclosure relates to an inside door handle mechanism for actuating a power release function and further including a mechanical backup release function.

### BACKGROUND

This section provides background information related generally to closure latch assemblies of the type used with closure panels in association with a motor vehicle closure system. This background information is only provided to describe the possible vehicular applications for such latch assemblies and is not intended to limit the scope of the present disclosure nor be interpreted as prior art thereto.

Modem passenger vehicles, such as automotive and electric vehicles, are provided with multiple doors or closure panels providing access to the interior of the vehicle. As is known, the doors are held in the closed position via a latch mechanism at an interface between the vehicle door and the vehicle frame.

Traditional latch mechanisms are actuated mechanically by a cable or wire that mechanically releases a ratchet that is configured to engage/release a striker that is typically fixed to the vehicle body. Upon actuation of the latch mechanism, the ratchet releases the striker and allows the vehicle door to be opened.

Mechanical actuation can be provided by the door handle, including both the inside door handle and the outside door handle. By actuating one of the handles, the wire connected to the handle will be pulled, which in turn pulls on a release mechanism of the latch to cause movement of the ratchet and release of the striker.

Vehicle latches may also be configured to move the ratchet and release the striker electrically in response to receiving a signal, where a motor or other electrical actuator causes movement of the ratchet to release the striker. The release signal may be communicated via an electrical wire, or may be communicated wirelessly by a transmitter.

In the case of electrical actuation, an inside or outside door handle may be actuated by the user, which causes a switch to send the electrical signal to the control system, which provides the electronic signal to the latch mechanism to move the ratchet and release the striker.

However, receipt of the signal and electrical actuation of the latch may be dependent on the vehicle power system and control system functioning correctly. In some instances, the vehicle power system or control system may malfunction or be otherwise inoperable. In such instances, electrical actuation of the latch to release the striker and allow the vehicle door to be opened will not occur.

Accordingly, vehicle door release actuation systems may include both an electrical release mechanism, which is the primary release system, along with a mechanical release system provided as a backup. Typically, the handle for the mechanical override or backup release mechanism is located at a remote location relative to the primary door handle mechanism that is provided for the electrical release actuation handle and switch. In another approach, the same handle may be used, but is actuated in a different direction or in a different way that the primary actuation.

The separate actuation mechanism, while providing a backup function, is not intuitive, and furthermore takes up valuable space in the vehicle door or body. The separate assemblies for electrical and mechanical release functions result in increased component cost and installation cost, as well as increasing the number of components to be assembled and potential areas for installation errors or other failure points. The use of different handles or the use of the same handle but in different ways can lead to confusion or repeated failed actuation of the electrical release function. Moreover, the integration of a door handle into the vehicle trim, in particular for an inside door handle, requires specific fit and finish to integrate into the vehicle door or related structure in a physically and aesthetically pleasing manner. Accounting for different actuation types of additional handles therefore provides further challenges to account for a desirable fit and finish.

Thus, there is a need for improvements to vehicle door handles that provide an electrical release function as well as a mechanical backup release function.

### SUMMARY

This section provides a general summary of the present disclosure and is not intended to be considered a comprehensive and exhaustive listing of all features, advantages, aspects and objectives associated with the inventive concepts described and illustrated in the detailed disclosure provided herein.

It is an aspect of the present disclosure to provide an inside door handle having both electrical and mechanical actuation functions that is actuated via a common kinematic movement of the door handle.

In one aspect, a door handle mechanism for providing electrical and mechanical release functions to a latch, the door handle mechanism comprising: a fixed base; a slider slidingly retained on the fixed base; a lever pivotally attached to the fixed base; an electrical switch attached to the fixed base; wherein rotation of the lever in a first direction through a first range of travel actuates the electrical switch for providing an electrical release signal for an electrical release function to release the latch; wherein additional movement of the lever in the first direction through a second range of travel mechanically actuates the slider and causes sliding movement of the slider relative to the base for providing a mechanical release function to release the latch.

In one aspect, the switch is coupled to the fixed base via a switch bracket.

In one aspect, the lever includes a handle portion that moves upwardly in the first direction of the lever.

In one aspect, the lever includes an actuator portion that moves downwardly in the first direction to actuate the switch.

In one aspect, the actuator portion includes a contact feature disposed adjacent to the switch, where the downward movement of the actuator portion moves the contact feature away from the switch and out of contact with the switch to actuate the switch.

In one aspect, the actuator portion includes a cam surface facing a corresponding cam surface of the slider, wherein rotation of the lever through the second range of travel contacts the cam surface of the actuation portion against the cam surface of the slider with and shifts the slider relative to the fixed base of the lever.

In one aspect, the cam surfaces are spaced apart during the first range of travel and contact each other at an end of the first range of travel, and the slider moves following the first range of travel of the lever.

In one aspect, the lever pivots relative to the fixed base through the first and second range of travel, wherein the upward movement of the handle portion and the downward movement of the actuation portion are part of the same kinematic movement of the lever in the first direction.

In one aspect, movement of the slider causes movement of a cable end for pulling on a mechanical actuation cable to mechanically actuate the latch.

In one aspect, the slider moves linearly relative to the base for pulling the cable end linearly.

In one aspect, the fixed base of the door handle is configured to be fixed in an arm rest of a vehicle door.

In one aspect, at least a portion of the fixed base is configured to be embedded within the arm rest and covered, such that a handle portion of the lever is exposed and accessible by a vehicle occupant.

In another aspect, a method of actuating a door handle for providing both electrical and mechanical release functionality to a latch includes: actuating a lever relative to a fixed base in a first direction through a first range of travel; in response thereto, actuating an electrical switch for providing an electrical signal to the latch; actuating the lever further relative to the fixed base in the first direction through a second range of travel beyond the first range of travel; in response thereto, contacting a slide, which is slidingly coupled to the fixed base, with the lever and shifting the slider relative to the fixed base, wherein the slider is configured to pull an attached cable for providing a mechanical release function to the latch.

In one aspect, the first direction is a pivotal direction relative to the fixed base.

In one aspect, the lever includes a handle portion that moves upward in the first direction.

In one aspect, the lever includes an actuation portion that moves downward in the first direction.

In one aspect, the actuation portion includes a contact feature that moves downwardly away from the electrical switch during the first range of travel.

In one aspect, the actuation portion includes a cam surface that moves toward contact with a corresponding cam surface of the slider during the first range of travel.

In one aspect, the cam surface of the actuation portion contacts the corresponding cam surface of the slider following the first range of travel, and forces the slider linearly relative to the base during the second range of travel.

In one aspect, the lever is biased against the first direction in both the first range of travel and the second range of travel.

In one aspect, a spring element disposed between the lever and the fixed base provides a bias against the first direction of the lever during the first range of travel, and the slider applies an additional biasing force against the first direction of the lever during the second range of travel.

Further areas of applicability will become apparent from the detailed description provided herein. The specific aspects and example embodiments listed in this summary are intended for illustrative purposes only and are not intended to limit the fair and reasonable scope of the present disclosure.

### BRIEF DESCRIPTION OF THE DRAWINGS

The drawings described herein are only intended to illustrate non-limiting embodiments of a door handle and its related structural configuration and functional operation in association with the teachings of the present disclosure. In the drawings:

FIG. 1 is an exploded view of a door handle mechanism according to the present disclosure, including various components for being attached to a fixed base structure;

FIG. 2 is a reverse exploded view of the door handle mechanism according to the present disclosure, including various components for being attached to a fixed base structure;

FIG. 3 is a sectional view of the door handle mechanism showing a lever having a contact portion in contact with a switch;

FIG. 4 is a further sectional view showing the door handle mechanism with the lever in a first actuated position, through a first range of travel from the position shown in FIG. 3, to cause electrical release of the latch;

FIG. 5 is a further sectional view of the door handle mechanism with the lever in a second actuated position, through a second range of travel beyond the first range of travel, with the slider in a shifted position to cause mechanical release of the latch via the linear movement of the slider and corresponding movement of an attached cable;

FIG. 6 is a perspective assembled view of the door handle mechanism with the lever shown in an at rest position corresponding to FIG. 3;

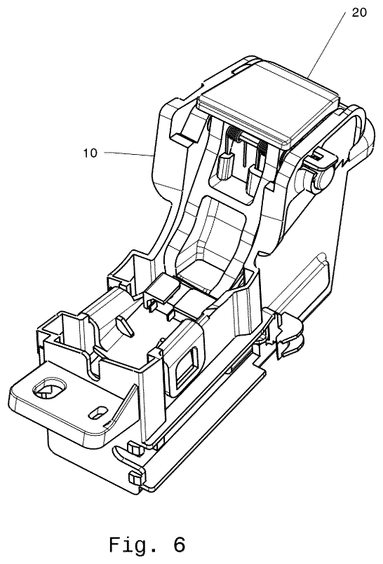

FIG. 7 is a further perspective view of the door handle mechanism with the lever in the first actuated position through the first range of travel, corresponding to FIG. 4, to cause electrical release of the latch;

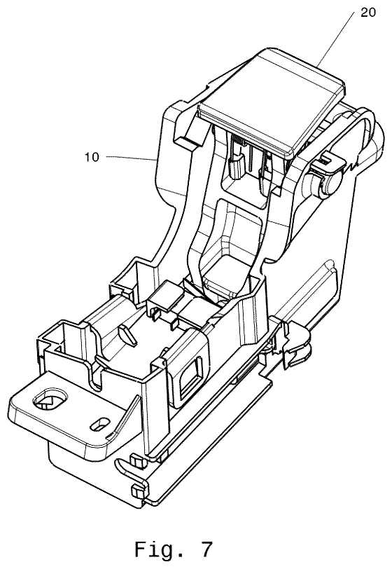

FIG. 8 is a further perspective view of the door handle mechanism with the lever in the second actuated position through the second range of travel beyond the first range of travel, corresponding to FIG. 5, with the slider in a shifted position to cause mechanical release of the latch via linear movement of the slider and corresponding movement of an attached cable;

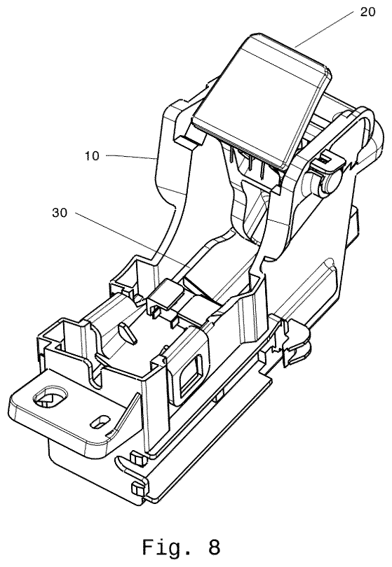

FIG. 9 is another perspective view of the door handle mechanism with the cable shown attached to the slider; and

FIG. 10 is a perspective view of the slider.

### DETAILED DESCRIPTION

Example embodiments of a door handle will now be described more fully with reference to the accompanying drawings. To this end, the example embodiments of the door handle are provided so that the disclosure will be thorough and will fully convey its intended scope to those who are skilled in the art. Accordingly, numerous specific details are set forth such as examples of specific components, devices, and methods, to provide a thorough understanding of particular embodiments of the present disclosure. However, it will be apparently to those skilled in the art that specific details need not be employed, that the example embodiments may be embodied in many different forms, and that the example embodiments should not be construed to limit the scope of the present disclosure. In some parts of the example embodiments, well-known processes, well-known device structures, and well-known technologies are not described in detail.

In the following detailed description, the expression “door handle” will be used to generally indicate any door handle configured for actuating a power-operated latch mechanism of a vehicle door and further configured to actuate a mechanical backup release function. Additionally, the expression “door” will be used to indicate any panel-type element configured to move between open and closed positions relative to a vehicle body.

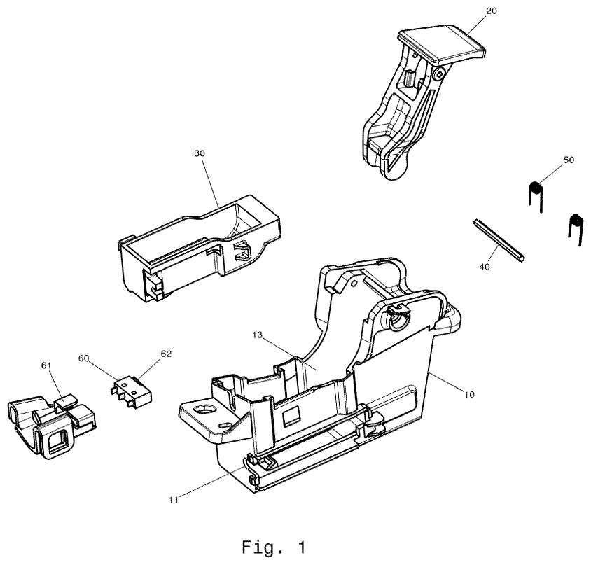

FIG. 1 illustrates an exploded view of a door handle mechanism, including a fixed base 10, a lever 20, a slider 30, a lever axis or pivot pin 40, a spring 50, a PCB/microswitch 60, and a switch bracket 61. Each of these components are assembled together, with the fixed base 10 being attachable to a vehicle structure, such as a vehicle door trim (not shown), such as an armrest or other internal vehicle structure where an inside door handle is typically provided. The slider 30 is secured to and slidable relative to the fixed base 10. The lever 20 is pivotable relative to the fixed base about the pivot pin 40. The PCB/microswitch 60 is attached in a fixed position to the switch bracket 61. The switch bracket 61 is attached in a fixed position to the base 10. The spring 50 is attached between the fixed base 10 and the lever 20, such that the spring biases the lever clockwise about the pin 40 (relative to the view shown in FIG. 1). The spring 50 is arranged to bias the handle portion of the lever 20 downward, opposite the upward actuation movement that will be applied to the handle, such that the lever is biased back toward its non-actuated position following an actuation movement.

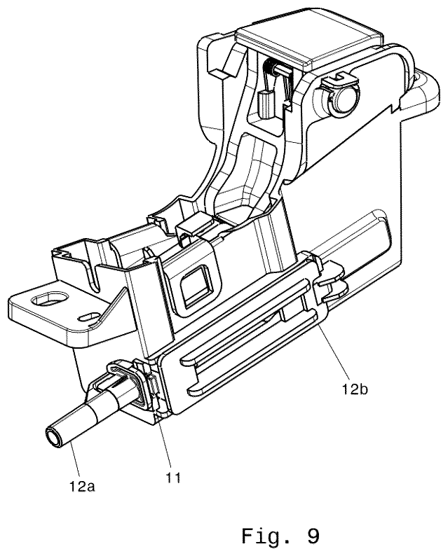

With reference to the base 10, the base includes an aperture 11 in an endwall for receiving a Bowden cable, including cable sleeve 12a (FIG. 9), and an end fitting 12b of the Bowden cable can be attached to the base 10 such that the cable will be attached to the slider 30 and will be pulled with the slider 30 when the slider 30 undergoes sliding movement. The cable is configured to extend to the door latch (not shown) installed within the vehicle for mechanically actuating the latch to provide a mechanical release function. The specifics of the release function within the latch can vary depending on the specifics of the latch design and are not the subject of this disclosure. In short, movement of the slider 30 pulls on the attached cable for actuating the associated latch.

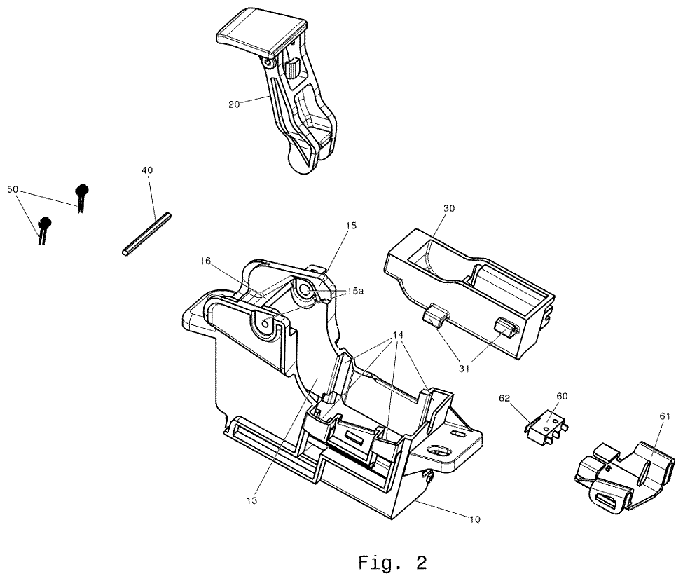

With reference now to FIG. 2, the base 10 includes an internal space 13, in which the slider 30 is slidingly disposed. The base includes a plurality of slots 14 formed in the sidewalls thereof, which are configured to receive corresponding projections 31 of the slider 30. The slots 14 retain the projections 31 and may limit the linear travel available to the slider 30. The 14 slots have an opening at a rear end thereof, in which the projections 31 of the slider 30 are received in a downward direction. The slider 30 may then be advanced forward along the slots 14, such that the slider 30 is retained within the base 10 and slidable relative to the base 10. The slider 30 is blocked from removal when the lever 20 is installed on the base 10.

The base 10 further includes, at the front end, a lever mount portion 15, which includes a pair of opposing tabs 15a that receive and retain the pin 40. The base 10 includes a front wall 16, against which one end of the spring (or springs) 50 will bear. The opposite side of the spring(s) bears against the lever 20 and biases the lever 20 about the pin 40 toward its non-actuated position (counter-clockwise in FIG. 2). The lever 20 extends downward into the internal space 13 of the base 10, above the front end (on the left in FIG. 2) of the slider 30.

The PCB/microswitch 60, which may also be referred to as switch 60, is attached to the switch bracket 61 via mounting features integrated into the structure of the bracket 61. The switch 60 includes a switch member 62 attached to the surface of switch 60. The switch 60 is in communication with a vehicle controller (not shown) either via a wired connection or a wireless connection (not shown). Actuation of the switch member 62 is communicated to the vehicle controller via the switch 60 and its connection with the controller in a manner known in the art.

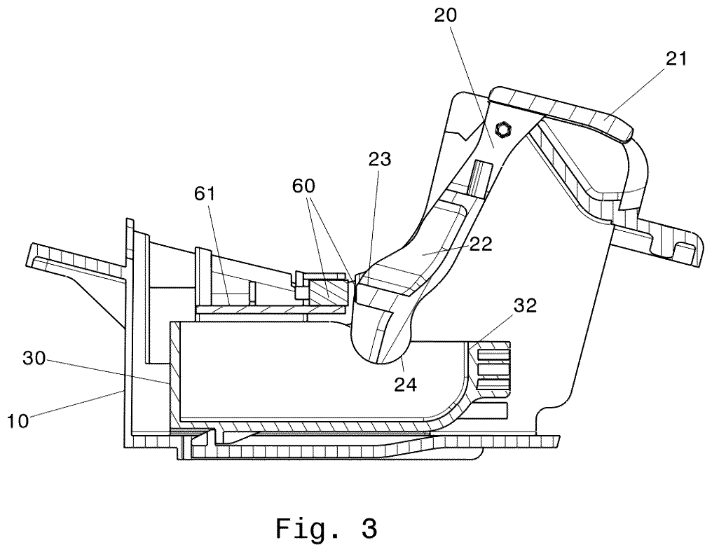

As shown in FIG. 3, with reference again to the lever 20, the lever 20 includes a handle portion 21 and an actuation portion 22. The handle portion 21 is the portion that is intended to be grabbed or otherwise handled by the vehicle occupant to control release of the door latch. The actuation portion 22 is preferable not visible or accessible to the vehicle occupant, and is preferably covered by other vehicle trim or the like, including other buttons or actuators, for example window actuators or lock/unlock actuators, and/or the door armrest. Similarly, the portion of the interior space 13 rearward relative to the handle portion 21, which houses the slider 30, switch 60, and actuation portion 22, may also be covered by the vehicle trim and not accessible, leaving the handle portion 21 as the primarily accessible feature.

The lever 20 is designed such that the handle portion 21 is pulled upward to provide an actuation. However it will be appreciated that benefits and advantages of this disclosure may also be provided where the lever 20 is moved downward, sideways, etc. depending on the orientation of the assembly. In such alternatives, the various biases may be arranged such that the lever 20 is biased to its non-actuated position. For purposes of the instant description, the illustrated arrangement (upward actuation of the handle portion 21) will be described herein. The handle portion 21 is pulled upward to provide both electrical actuation of the latch and also mechanical backup actuation in the event of electrical failure.

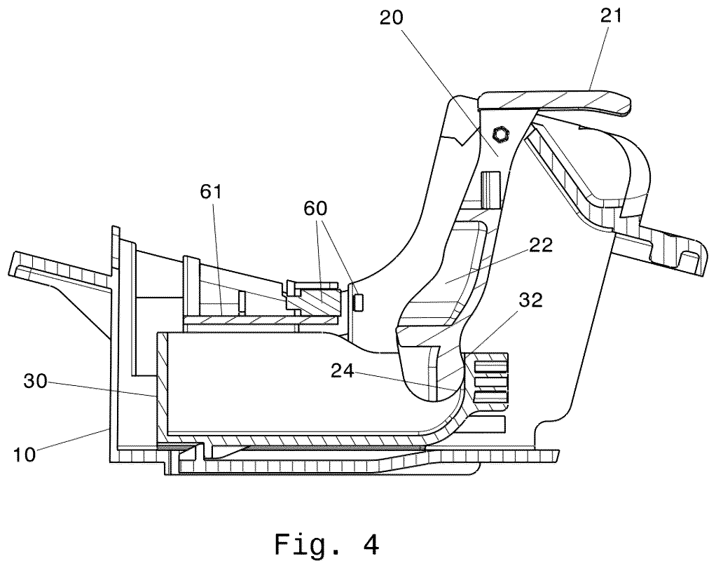

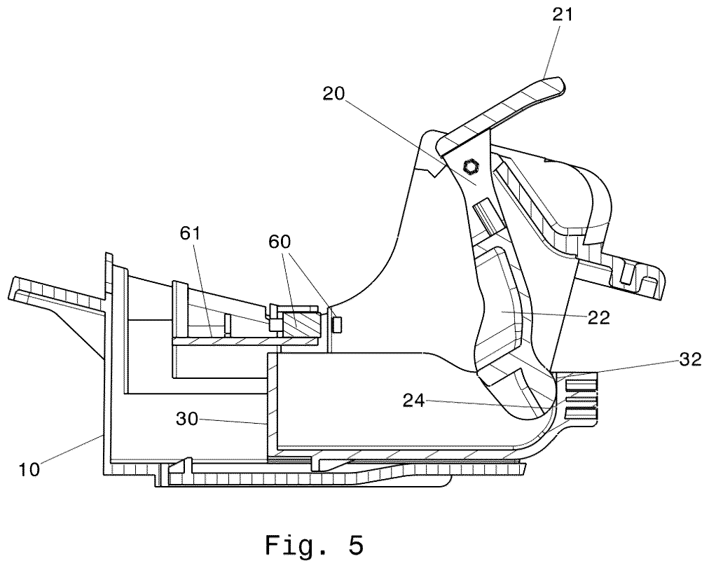

As shown in FIG. 4, upward movement of the handle portion 21 causes the lever 20 to pivot about the pin 40, thereby causing downward movement of the actuation portion 22. The downward movement is based on the pivoting movement of the lever 20, and accordingly also moves to the right form FIG. 3 to FIG. 4. The downward movement of the actuation portion 22 provides multiple functions. During a first range of travel, the downward movement of the actuation portion 22 moves the contact feature 23 away from engagement with the switch member 62, which causes the switch 60 to actuate and provide a signal that the lever 20 has been actuated through the first range of travel. During a second range of travel (from the position of FIG. 4 to the position of FIG. 5), the downward movement of the actuation portion 22 causes contact with the slider 30, which moves the slider in a linear forward direction along the fixed base 10 (FIG. 5). The downward movement may accordingly also be considered forward movement, causing the linear forward sliding movement of the slider 30 relative to the fixed base 10.

To provide the above dual actuation, the lever 20 further includes a contact feature 23 extending rearwardly from the lower end of the actuation portion 22. The contact feature 23 is arranged adjacent to the switch 60, and is in contact with the switch member 62 when the lever 20 is at its normal or rest position (FIG. 3). The switch 60 may be a mechanical switch with a button or the like, and can be designed as a normally closed switch that opens when the contact feature 23 moves out of contact with the switch member 62, or may be a normally open switch that closes when the contact feature 23 moves out of contact with the switch member 62. The switch 60 will transition from the normally open/closed in response to movement of the contact feature 23 away from the switch member 62 (based on the downward and forward movement of the actuation portion 22 of the lever 20), and then will transition back to the normally open/closed state in response to the contact feature 23 moving back into contact with the switch member 62 after an actuation is complete and lever 20 returns to its non-actuated position.

To provide the mechanical release function and sliding movement of the slider 30 relative to the base 10, the lever 20 further includes a forward facing cam surface 24 on opposite lateral sides of the actuation portion 22. The forward facing cam surface 24 is designed to cooperate with a rearward facing cam surface 32 of the slider 30. The respective cam surfaces are arranged such that the pivoting downward movement of the actuation portion 20 provides a forward and downward force onto the slider 30. In one aspect the cam surfaces 32 on the slider are arranged generally vertically, and the cam surfaces of the 24 of the lever 20 are curved. The bottom of the actuation portion 22 may likewise be curved, such that as the lever 20 continues to pivot, the cam surfaces 24 may slide along the cam surface 32. The slider 30, being retained by the fixed base 10 and slidable relative to the slots, thereby slides forward in response to the downward pivot movement of the lever 20. It will be appreciated that other cam surface arrangements may also be used. The cam surface 32 of the slider 30 is disposed on the interior of the slider 30, with the bottom of the actuation portion 22 extending in to the interior of the slider 30. While a pair of cam surfaces 24 are shown at the laterally outward sides of the actuation portion 22, it will be appreciated that a single cam surface 24 could also be used to contact the slider 30 and translate the slider 30.

In the position shown in FIG. 3, preferably, the cam surfaces 24, 32 are spaced apart from each other when the lever 20 is in its non-actuated position. Movement of the lever 20 through the first range of travel brings the cam surfaces toward each other as the switch 60 is actuated by the movement of the contact feature 23 away from the switch 60. Once through the first range of travel, the cam surfaces 24, 32 will contact each other (as shown in FIG. 4), and movement through the second range of travel will force the slider 30 forward relative to the base 10 (FIG. 5).

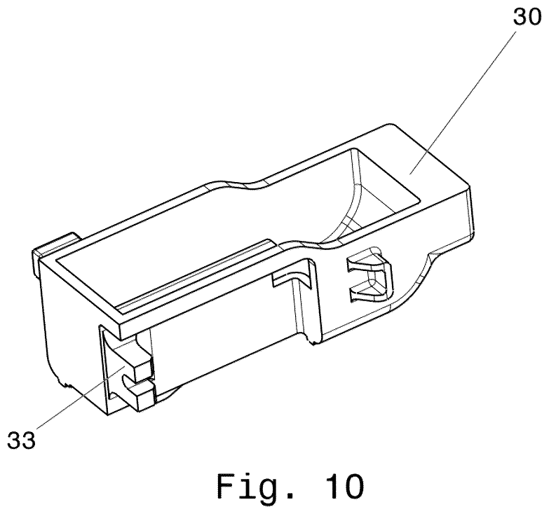

With reference to FIG. 10, the slider 30 includes a cable holder 33, shown in the form of a pair of shoulders extending outwardly from a side wall of the slider 30. The shoulders are spaced apart such that the cable sleeve 12a (having the cable attached thereto) can be fitted therewith. The actuatable cable is typically held in tension by the downstream latch mechanism, which provides a biasing force on the cable against the shoulders of the cable holder 33. Sliding movement of the slider 30 relative to the base 10 will pull on the cable, and the cable will provide a reaction/return force on the slider 30 to bias the slider 30 back toward its non-actuation position. The slider 30 is stopped in the rearward direction by the fixed base 10 as the cable is retracted to its original position. The fixed base 10 may include stopping features that cooperate with corresponding structure of the slider 30 to limit rearward movement.

FIGS. 3-5 illustrate the movement of the lever 20 and slider 30 from the non-actuated position (FIG. 3), through the first range of travel (FIG. 4) without movement of the slider 30, and through the second range of travel (FIG. 5), which causes sliding movement of the slider 30. In FIG. 4, the handle portion 21 has moved upward relative to FIG. 3, but the slider 30 remains in the same position. In FIG. 5, the handle portion 21 has moved further upward, the slider 30 is shown shifted to the right in a linear direction.

During this movement, the spring 50 (not shown in these figures) becomes compressed, exerting a return force on the lever 20 to bias the lever 20 back toward the non-actuated or rest position. The spring bias will return the lever 20 to its at-rest position, and the at-rest positioning may be maintained via contact with the pivot structure of the fixed based 10.

The above description of the mechanism 100 illustrates the conversion of rotational or pivoting movement of the handle 20 in the same kinematic motion or direction to provide both electrical and mechanical release. The conversion of the rotational movement to linear movement of the slider allows the corresponding attached mechanical actuation cable to move linearly, thereby simplifying the mechanical actuation and providing a more direct and efficient mechanical actuation of the downstream door latch. By using the linear translation and actuation of the cable, the payout of the cable through a rotating connection and the pivot location can be eliminated, unlike other mechanical cables attached to a pivoting door handle.

The above mechanism may be installed and integrated with the vehicle door trim internally, such that substantially only the handle portion 21 is visible or accessible by the vehicle occupant. The necessary electrical connections may be integrated within the base 10.

During the movement through the first range of travel, the slider 30 may be biased rearwardly via the attached mechanical actuation cable such that the movement of the lever 20 may be initially stopped by its initial contact with the slider 30, with the second range of travel being provided by continued rotation at a higher force than during the first range of travel. Thus, during normal operation when electrical actuation occurs, the vehicle occupant may not typically move the handle 21 and lever 20 through the second range of travel. The spring 50 provides the necessary return force on the handle 21 when the handle 21 remains in the first range of travel. When the handle 21 moves through the second range of travel, additional return force may be provided by tension in the actuation cable.

During operation in which the electrical release is functioning, return of the lever 20 to its at-rest position will cause contact by the actuation portion 22 of the lever 20 again with the switch member 62, which may signal to the controller via switch 60 that an electrical actuation is requested. Or, the signal may occur as soon as the switch is out of contact with the handle, depending on the preferred control scheme.

In the event of power failure, following the return of the lever 20 into contact with the switch 60, the controller will receive a signal when power returns, indicating the electrical actuation is again available.

The above door mechanism can be provided into new designs, and may also be provided to existing vehicle trims as a retro-fit or aftermarket product.

The ranges of travel described and illustrated may be adjusted depending on design needs or user preference. In any case, the same kinematic movement can be used to provide the electrical release prior to continued movement in the same direction to provide the mechanical release. Thus, the end user can use the same motion to effect a release of the latch, reducing instances of confusion or failure related to accessing and actuating a mechanical backup release function.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A door handle mechanism for providing electrical and mechanical release functions to a latch, the door handle mechanism comprising:
a fixed base;
a slider slidingly retained on the fixed base;
a lever pivotally attached to the fixed base;
an electrical switch coupled to the fixed base;
wherein rotation of the lever in a first direction through a first range of travel actuates the electrical switch for providing an electrical release signal for an electrical release function to release the latch;
wherein additional movement of the lever in the first direction through a second range of travel mechanically actuates the slider and causes sliding movement of the slider relative to the base for providing a mechanical release function to release the latch.

2. The door handle of claim 1, wherein the lever includes a handle portion that moves upwardly in the first direction of the lever.

3. The door handle of claim 2, wherein the lever includes an actuator portion that moves downwardly in the first direction to actuate the switch.

4. The door handle of claim 3, wherein the actuator portion includes a contact feature disposed adjacent to the switch, where the downward movement of the actuator portion moves the contact feature away from the switch and out of contact with the switch to actuate the switch.

5. The door handle of claim 3, wherein the actuator portion includes a cam surface facing a corresponding cam surface of the slider, wherein rotation of the lever through the second range of travel contacts the cam surface of the actuation portion against the cam surface of the slider with and shifts the slider relative to the fixed base of the lever.

6. The door handle of claim 5, wherein the cam surfaces are spaced apart during the first range of travel and contact each other at an end of the first range of travel, and the slider moves following the first range of travel of the lever.

7. The door handle of claim 1, wherein the lever pivots relative to the fixed base through the first and second range of travel, wherein the upward movement of the handle portion and the downward movement of the actuation portion are part of the same kinematic movement of the lever in the first direction.

8. The door handle of claim 1, wherein movement of the slider causes movement of a cable end for pulling on a mechanical actuation cable to mechanically actuate the latch.

9. The door handle of claim 8, wherein the slider moves linearly relative to the base for pulling the cable end linearly.

10. The door handle of claim 1, wherein the fixed base of the door handle is configured to be fixed in an arm rest of a vehicle door.

11. The door handle of claim 10, wherein at least a portion of the fixed base is configured to be embedded within the arm rest and covered, such that a handle portion of the lever is exposed and accessible by a vehicle occupant.

12. A method of actuating a door handle for providing both electrical and mechanical release functionality to a latch, the method comprising:
actuating a lever relative to a fixed base in a first direction through a first range of travel;
in response thereto, actuating an electrical switch for providing an electrical signal to the latch;
actuating the lever further relative to the fixed base in the first direction through a second range of travel beyond the first range of travel;
in response thereto, contacting a slider, which is slidingly coupled to the fixed base, with the lever and shifting the slider relative to the fixed base, wherein the slider is configured to pull an attached cable for providing a mechanical release function to the latch.

13. The method of claim 12, wherein the first direction is a pivotal direction relative to the fixed base.

14. The method of claim 13, wherein the lever includes a handle portion that moves upward in the first direction.

15. The method of claim 14, wherein the lever includes an actuation portion that moves downward in the first direction.

16. The method of claim 15, wherein the actuation portion includes a contact feature that moves downwardly away from the electrical switch during the first range of travel.

17. The method of claim 16, wherein the actuation portion includes a cam surface that moves toward contact with a corresponding cam surface of the slider during the first range of travel.

18. The method of claim 17, wherein the cam surface of the actuation portion contacts the corresponding cam surface of the slider following the first range of travel, and forces the slider linearly relative to the base during the second range of travel.

19. The method of claim 18, wherein the lever is biased against the first direction in both the first range of travel and the second range of travel.

20. The method of claim 19, wherein a spring element disposed between the lever and the fixed base provides a bias against the first direction of the lever during the first range of travel, and the slider applies an additional biasing force against the first direction of the lever during the second range of travel.
